(19) United States
(12) Patent Application Publication
(10) Pub. No.: US 2009/0173120 A1
(43) Pub. Date: Jul. 9, 2009

(54) Electric Door Lock

(75) Inventors: Lung-Yin Lin, Nan-Tou Hsien (TW); Chuan-Tien Fan, Taipei City (TW)

Correspondence Address: BINGHAM MCCUTCHEN LLP, Three Embarcadero Center, San Francisco, CA, 94111-4067, US

(73) Assignee: LONG CYUAN CO., LTD., Chiayi City (TW)

(21) Appl. No.: 11/968,879

(22) Filed: Jan. 3, 2008

(51) Int. Cl. E05B 47/00

(52) U.S. Cl. 70/279.1

(57) ABSTRACT

An electric door lock includes a rotatable member, a driving unit, and a manual operating member. The rotatable member is rotatable in first and second rotational directions and is provided with a first protrusion. The driving unit is coupled to the rotatable member, and operable so as to drive rotation of the rotatable member. The manual operating member is rotatable between locking and unlocking positions and is provided with a second protrusion. The first protrusion pushes the second protrusion to permit rotation of the manual operating member between the locking and unlocking positions when the rotatable member is driven by the driving unit to rotate in the first and second rotational directions, respectively. The second protrusion slides over the first protrusion when the manual operating member is driven to rotate between the locking and unlocking positions and when the driving unit is deactivated.

### BACKGROUND OF THE INVENTION

1. Field of the Invention

This invention relates to a door lock, more particularly to an electric door lock.

2. Description of the Related Art

In U.S. Patent Application Publication No. 2004/0245785, there is disclosed a conventional electric door lock that includes a lock housing, a manual operating member, first and second rotatable members, and a driving unit. The manual operating member extends rotatably into the lock housing, and is rotatable relative to the lock housing between locking and unlocking positions. The first rotatable member is in the form of a sector gear that has gear teeth, and is mounted rotatably in the lock housing. The second rotatable member is in the form of a gear that has gear teeth, is mounted rotatably in the lock housing, and is coupled to the manual operating member such that the second rotatable member coaxially rotates with the manual operating member between the locking and unlocking positions.

In operation, at an initial position, in which the manual operating member is disposed at the locking position, activation of the motor of the driving unit results in clockwise rotation of the first rotatable member, eventual engagement between the gear teeth of the first rotatable member and the gear teeth of the second rotatable member, co-rotation of the manual operating member and the second rotatable member to the unlocking position, and eventual disengagement of the gear teeth of the first rotatable member from the gear teeth of the second rotatable member. At this time, the manual operating member may be manually rotated between the locking and unlocking positions. Reactivation of the motor of the driving unit results in counter-clockwise rotation of the first rotatable member, eventual engagement between the gear teeth of the first rotatable member and the gear teeth of the second rotatable member, co-rotation of the manual operating member and the second rotatable member back to the locking position, and eventual disengagement of the gear teeth of the first rotatable member from the gear teeth of the second rotatable member. At this time, the manual operating member may be manually rotated between the locking and unlocking positions.

The aforesaid conventional electric door lock is disadvantageous in that, since each of the gear teeth of each of the first and second rotatable members has a certain degree of thickness, when the first and second rotatable members are converted from a non-engaging to an engaging state, proper engagement between the gear teeth of the first rotatable member and the gear teeth of the second rotatable member cannot be ensured during operation of the conventional electric door lock.

### SUMMARY OF THE INVENTION

Therefore, the object of the present invention is to provide an electric door lock that can overcome the aforesaid drawback of the prior art.

According to the present invention, an electric door lock comprises a lock housing, a rotatable member, a driving unit, and a manual operating member. The lock housing defines an axis. The rotatable member is disposed in the lock housing, is rotatable relative to the lock housing about the axis in first and second rotational directions, and is provided with at least one first protrusion. The driving unit is disposed in the lock housing, is coupled to the rotatable member, and is operable so as to drive rotation of the rotatable member about the axis. The manual operating member extends into the lock housing, is rotatable relative to the lock housing about the axis between locking and unlocking positions, and is provided with at least one second protrusion. The first protrusion pushes the second protrusion to permit rotation of the manual operating member about the axis between the locking and unlocking positions when the rotatable member is driven by the driving unit to rotate about the axis in the first and second rotational directions, respectively. The second protrusion slides over the first protrusion when the manual operating member is driven to rotate about the axis between the locking and unlocking positions and when the driving unit is deactivated.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of the first preferred embodiment of an electric door lock according to the present invention;

FIG. 2 is a fragmentary sectional view of the first preferred embodiment in an assembled state;

FIG. 3 is a schematic view to illustrate a manual operating member of the first preferred embodiment;

FIGS. 4 and 5 are schematic views to illustrate automatic operation of the first preferred embodiment;

FIG. 6 is an exploded perspective view of the second preferred embodiment of an electric door lock according to the present invention;

FIG. 7 is a schematic view to illustrate automatic operation of the second preferred embodiment;

FIG. 8 is a fragmentary partly sectional view to illustrate a pair of first protrusions and a pair of second protrusions of the second preferred embodiment; and

FIG. 9 is a schematic view of the third preferred embodiment of an electric door lock according to the present invention.

### DETAILED DESCRIPTION OF THE PREFERRED EMBODIMENTS

Before the present invention is described in greater detail, it should be noted that like elements are denoted by the same reference numerals throughout the disclosure.

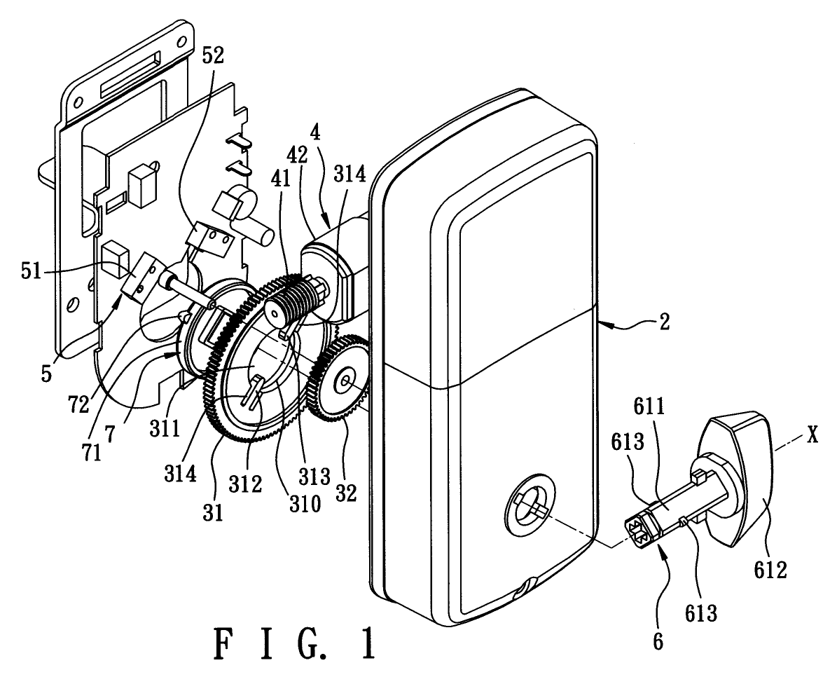

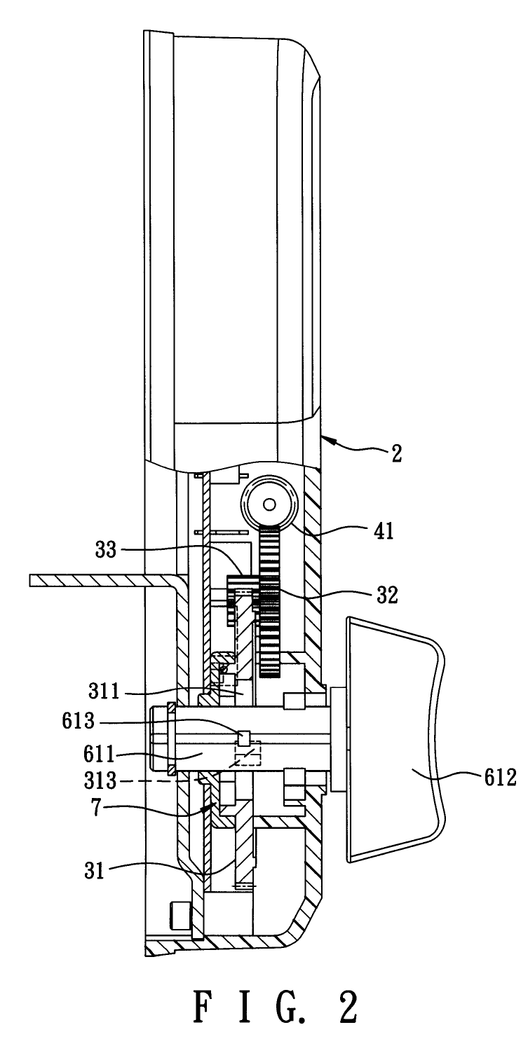

Referring to FIGS. 1 and 2, the first preferred embodiment of an electric door lock according to this invention is shown to include a lock housing 2, a rotatable member 31, a driving unit 4, and a manual operating member 6.

The lock housing 2 defines an axis (X) that extends through the manual operating member 6 when the electric door lock is assembled.

The rotatable member 31 is disposed in the lock housing 2, is rotatable relative to the lock housing 2 about the axis (X) in first and second rotational directions, is provided with a pair of diametrically opposite first protrusions 312, 313, and is formed with an axial hole 311 therethrough defined by a hole-defining wall 310. The hole-defining wall 310 of the rotatable member 31 is formed with a pair of diametrically opposite radial grooves 314. Each of the first protrusions 312, 313 is disposed in a respective one of the radial grooves 314, extends radially from the rotatable member 31 toward the axis (X), and has a rounded tip that extends into the axial hole 311 in the rotatable member 31. In this embodiment, the rotatable member 31 is a gear.

The driving unit 4 is disposed in the lock housing 2, is coupled to the rotatable member 31, and is operable so as to drive rotation of the rotatable member 31 about the axis (X). In particular, the electric door lock further includes first and second gears 32, 33. The first gear 32 is disposed in the lock housing 2. The second gear 33 is disposed in the lock housing 2, is connected to the first gear 32 such that the second gear 33 coaxially rotates with the first gear 32, and meshes with the rotatable member 31. The driving unit 4 includes a motor 42 that has a transmission shaft, and a worm gear 41 that is secured to the transmission shaft and that meshes with the first gear 32.

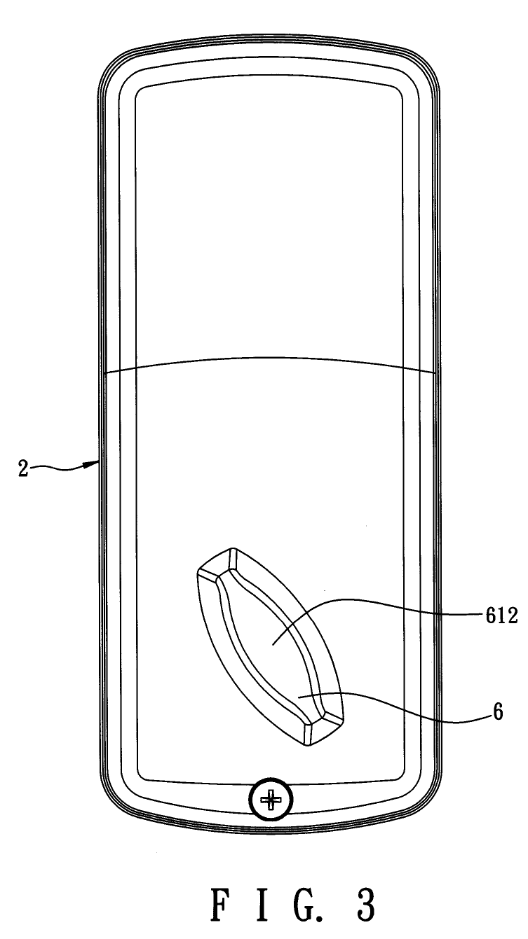

With further reference to FIG. 3, the manual operating member 6 includes a shaft 611 and a knob 612. The shaft 611 of the manual operating member 6 extends into the lock housing 2 and through the axial hole 311 in the rotatable member 31, and is rotatable relative to the lock housing 2 about the axis (X) between locking and unlocking positions. The knob 612 of the manual operating member 6 is disposed externally of the lock housing 2, and is connected to the shaft 611 of the manual operating member 6. In this embodiment, the shaft 611 of the manual operating member 6 is provided with a pair of diametrically opposite second protrusions 613.

The electric door lock further includes a switch unit 5 and an actuating unit 7. The switch unit 5 is disposed in the lock housing 2, and includes a pair of angularly displaced contact switches 51, 52, each of which is coupled to the motor 42 of the driving unit 4 and deactivates the motor 42 of the driving unit 4 when actuated. In this embodiment, each of the contact switches 51, 52 is a micro-switch. The actuating unit 7 is disposed in the lock housing 2, and includes a plate 71 and a switch actuator 72. The plate 71 of the actuating unit 7 is sleeved fixedly on the shaft 611 of the manual operating member 6 such that the plate 71 of the actuating unit 7 co-rotates with the shaft 611 of the manual operating member 6. The switch actuator 72 of the actuating unit 7 is provided on the plate 71 of the actuating unit 7, and actuates the contact switches 51, 52 of the switch unit 5 when the shaft 611 of the manual operating member 6 is disposed at the locking and unlocking positions, respectively.

In operation, when it is desired to manually operate the electric door lock of this embodiment, the knob 612 of the manual operating member 6 is rotated to drive rotation of the shaft 611 of the manual operating member 6 about the axis (X) from the locking position to the unlocking position, and vice versa. During such manual operation of the electric door lock of this embodiment, since the motor 42 of the driving unit 4 is deactivated, each of the second protrusions 613 simply slides over the rounded tip of a respective one of the first protrusions 312, 313.

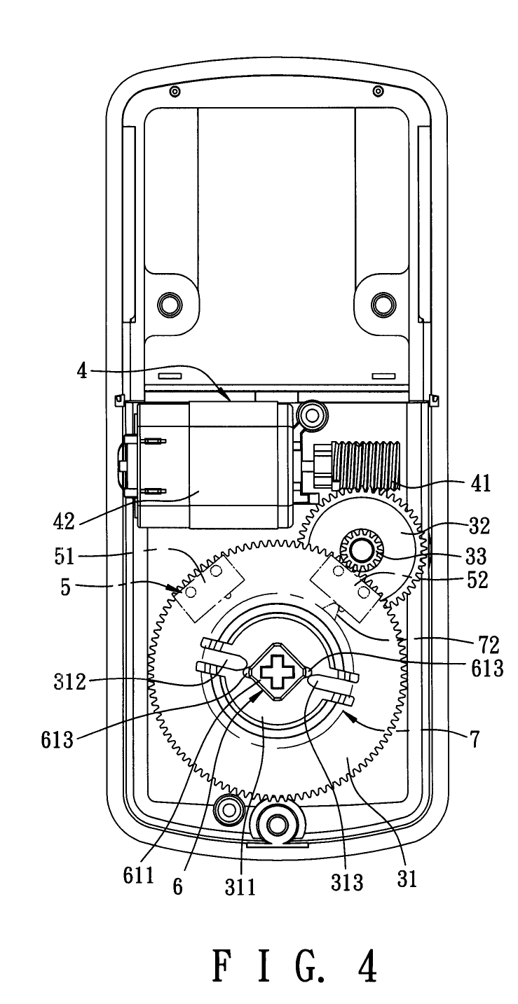

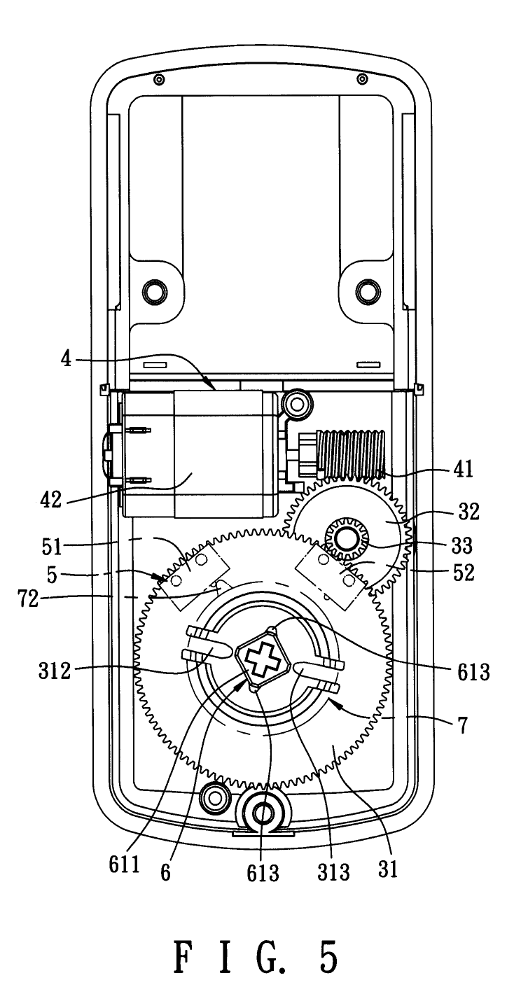

Moreover, as illustrated in FIG. 4, when the shaft 611 of the manual operating member 6 is disposed at the locking position, and when it is desired to automatically operate the electric door lock of this invention such as to dispose the shaft 611 of the manual operating member 6 from the locking position to the unlocking position, the motor 42 of the driving unit 4 is activated, such as with the use of a remote controller (not shown) or a magnetic card (not shown). This results in co-rotation of the first and second gears 32, 33, rotation of the rotatable member 31 in the first rotational direction to thereby permit each of the first protrusions 312, 313 to push a respective one of the second protrusions 613, rotation of the shaft 611 of the manual operating member 6 from the locking position to the unlocking position, and actuation of the contact switch 52 of the switch unit 5 by the switch actuator 72 of the actuating unit 7, thereby deactivating the motor 42 of the driving unit 4. Thereafter, as illustrated in FIG. 5, when it is desired to automatically operate the electric door lock of this invention so as to dispose the shaft 611 of the manual operating member 6 from the unlocking position back to the locking position, the motor 42 of the driving unit 4 is reactivated. This results in co-rotation of the first and second gears 32, 33, rotation of the rotatable member 31 in the second rotational direction to thereby permit each of the first protrusions 312, 313 to push the respective one of the second protrusions 613, rotation of the shaft 611 of the manual operating member 6 from the unlocking position to the locking position, and actuation of the contact switch 51 of the switch unit 5 by the switch actuator 72 of the actuating unit 7, thereby deactivating the motor 42 of the driving unit 4.

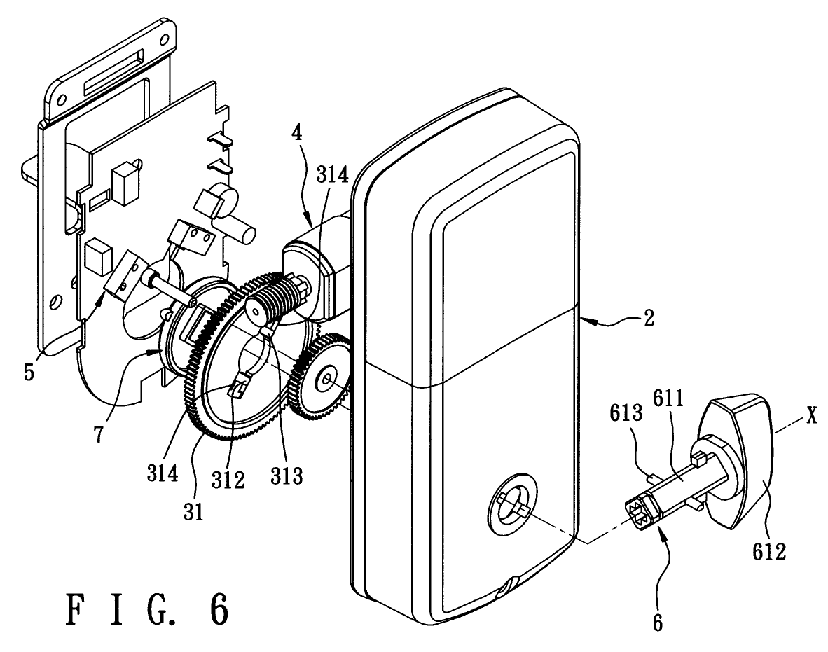

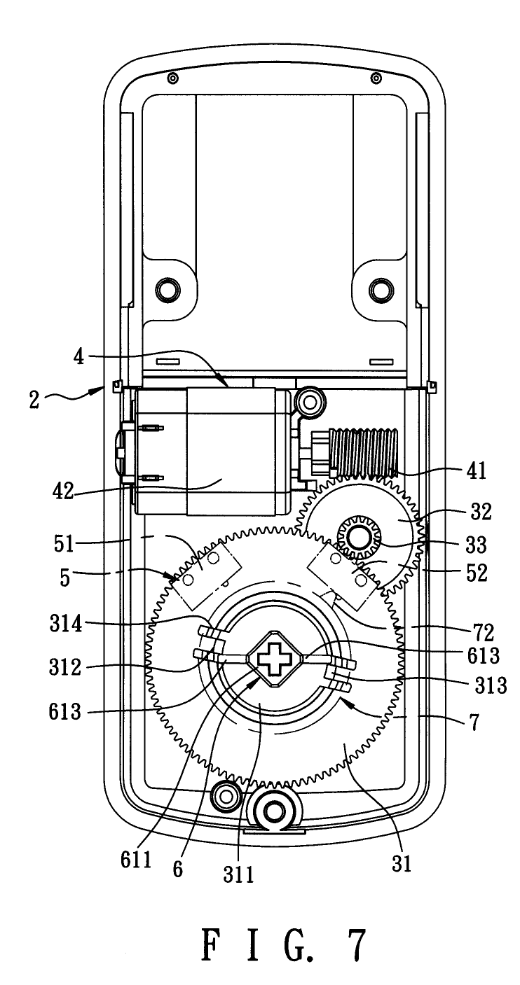

FIGS. 6 and 7 illustrate the second preferred embodiment of an electric door lock according to this invention. When compared to the previous embodiment, the rounded tip of each of the first protrusions 312, 313 extends axially, and is disposed externally of a respective one of the radial grooves 314 in the rotatable member 31.

Since manual operation of the electric door lock of this embodiment is similar to that described hereinabove in connection with the previous embodiment, a detailed description of the same will be dispensed with herein for the sake of brevity.

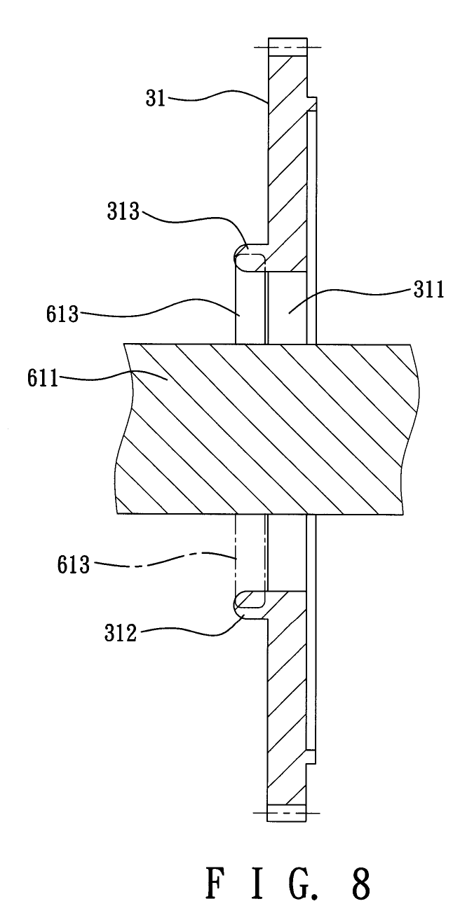

As illustrated in FIG. 7, when the shaft 611 of the manual operating member 6 is disposed at the locking position, and when it is desired to automatically operate the electric door lock of this invention so as to dispose the shaft 611 of the manual operating member 6 from the locking position to the unlocking position, the motor 42 of the driving unit 4 is activated, such as with the use of a remote controller (not shown) or a magnetic card (not shown). This results in co-rotation of the first and second gears 32, 33, rotation of the rotatable member 31 in the first rotational direction to thereby permit each of the first protrusions 312, 313 to push a respective one of the second protrusions 613, as illustrated in FIG. 8, rotation of the shaft 611 of the manual operating member 6 from the locking position to the unlocking position, and actuation of the contact switch 52 of the switch unit 5 by the switch actuator 72 of the actuating unit 7, thereby deactivating the motor 42 of the driving unit 4. Thereafter, when it is desired to automatically operate the electric door lock of this invention so as to dispose the shaft 611 of the manual operating member 6 from the unlocking position back to the locking position, the motor 42 of the driving unit 4 is reactivated. This results in co-rotation of the first and second gears 32, 33, rotation of the rotatable member 31 in the second rotational direction to thereby permit each of the first protrusions 312, 313 to push the respective one of the second protrusions 613, rotation of the shaft 611 of the manual operating member 6 from the unlocking position to the locking position, and actuation of the contact switch 51 of the switch unit 5 by the switch actuator 72 of the actuating unit 7, thereby deactivating the motor 42 of the driving unit 4.

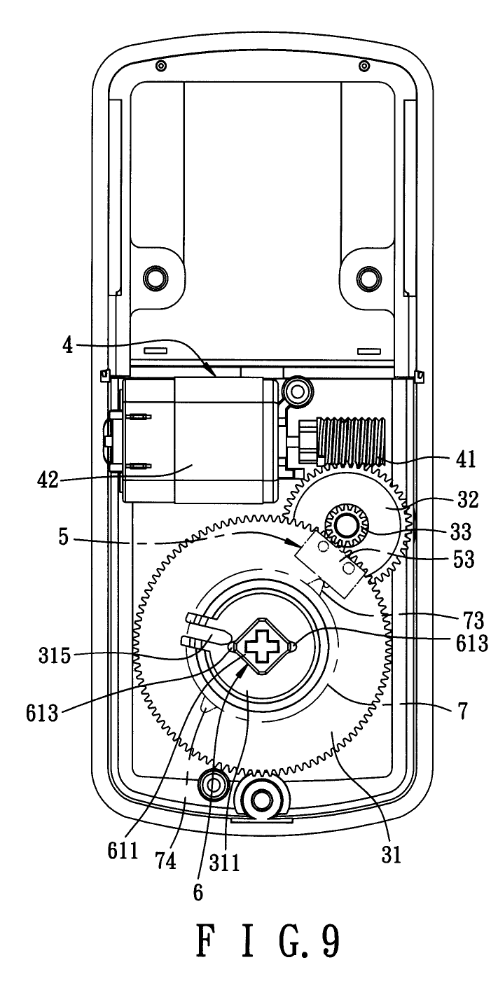

FIG. 9 illustrates the third preferred embodiment of an electric door lock according to this invention. When compared to the previous embodiments, the rotatable member 31 is provided with a first protrusion 315. The switch unit 5 includes a contact switch 53. The actuating unit 7 includes a pair of diametrically opposite switch actuators 73, 74.

Since manual operation of the electric door lock of this embodiment is the same to that described hereinabove in connection with the previous embodiment, a detailed description of the same will be dispensed with herein for the sake of brevity.

When the shaft 611 of the manual operating member 6 is disposed at the locking position, and when it is desired to automatically operate the electric door lock of this invention, the motor 42 of the driving unit 4 is activated, such as with the use of a remote controller (not shown) or a magnetic card (not shown). This results in co-rotation of the first and second gears 32, 33, rotation of the rotatable member 31 in the first rotational direction to thereby permit the first protrusion 315 to push one of the second protrusions 613, rotation of the shaft 611 of the manual operating member 6 from the locking position to the unlocking position, and actuation of the contact switch 53 of the switch unit 5 by the switch actuator 73 of the actuating unit 7, thereby deactivating the motor 42 of the driving unit 4. Thereafter, when it is desired to automatically operate the electric door lock of this invention so as to dispose the shaft 611 of the manual operating member 6 from the unlocking position back to the locking position, the motor 42 of the driving unit 4 is reactivated. This results in co-rotation of the first and second gears 32, 33, rotation of the rotatable member 31 in the second rotational direction to thereby permit the first protrusion 315 to push the other one of the second protrusions 613, rotation of the shaft 611 of the manual operating member 6 from the unlocking position to the locking position, and actuation of the contact switch 53 of the switch unit 5 by the switch actuator 73 of the actuating unit 7, thereby deactivating the motor 42 of the driving unit 4.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electric door lock, comprising:
a lock housing defining an axis;
a rotatable member disposed in said lock housing, rotatable relative to said lock housing about the axis in first and second rotational directions, and provided with at least one first protrusion;
a driving unit disposed in said lock housing, coupled to said rotatable member, and operable so as to drive rotation of said rotatable member about the axis; and
a manual operating member extending into said lock housing, rotatable relative to said lock housing about the axis between locking and unlocking positions, and provided with at least one second protrusion;
said first protrusion pushing said second protrusion to permit rotation of said manual operating member about the axis between the locking and unlocking positions when said rotatable member is driven by said driving unit to rotate about the axis in the first and second rotational directions, respectively;
said second protrusion sliding over said first protrusion when said manual operating member is driven to rotate about the axis between the locking and unlocking positions and when said driving unit is deactivated.

2. The electric door lock as claimed in claim 1, wherein said rotatable member is formed with an axial hole therethrough defined by a hole-defining wall,
said hole-defining wall of said rotatable member being formed with a radial groove,
said first protrusion being disposed in said radial groove, extending radially from said rotatable member toward the axis, and having a tip that extends into said axial hole in said rotatable member.

3. The electric door lock as claimed in claim 1, wherein said rotatable member is formed with an axial hole therethrough defined by a hole-defining wall,
said hole-defining wall of said rotatable member being formed with a radial groove,
said first protrusion being disposed in said radial groove, extending radially from said rotatable member toward the axis, and having a tip that extends axially, and that is disposed externally of said radial groove in said rotatable member.

4. The electric door lock as claimed in claim 1, wherein said rotatable member is provided with a pair of said first protrusions, and said manual operating member is provided with a pair of said second protrusions.

5. The electric door lock as claimed in claim 4, wherein said rotatable member is formed with an axial hole therethrough defined by a hole-defining wall,
said hole-defining wall of said rotatable member being formed with a pair of radial grooves,
each of said first protrusions being disposed in a respective one of said radial grooves, extending radially from said rotatable member toward the axis, and having a tip that extends into said axial hole in said rotatable member.

6. The electric door lock as claimed in claim 4, wherein said rotatable member is formed with an axial hole therethrough that is defined by a hole-defining wall,
said hole-defining wall of said rotatable member being formed with a pair of radial grooves,
each of said first protrusions being disposed in a respective one of said radial grooves, extending radially from said rotatable member toward the axis, and having a tip that extends axially and that is disposed externally of said radial groove in said rotatable member.

7. The electric door lock as claimed in claim 1, wherein said rotatable member is a toothed wheel.

8. The electric door lock as claimed in claim 7, further comprising:
a first gear disposed in said lock housing; and
a second gear disposed in said lock housing, coupled to said first gear such that said second gear coaxially rotates with said first gear, and meshing with said rotatable member, said driving unit including a motor that has a transmission shaft, and a worm gear that is secured to said transmission shaft and that meshes with said first gear.

9. The electric door lock as claimed in claim 1, further comprising:
a switch unit disposed in said lock housing, coupled to said driving unit, and deactivating said driving unit when actuated; and
an actuating unit disposed in said lock housing, provided on said manual operating member, and actuating said switch unit when said manual operating member is disposed at the locking and unlocking positions.

10. The electric door lock as claimed in claim 9, wherein said switch unit includes a pair of contact switches, and said actuating unit includes
a plate coupled to said manual operating member such that said plate co-rotates with said manual operating member, and
a switch actuator provided on said plate.

11. The electric door lock as claimed in claim 9, wherein said switch unit includes a contact switch, and said actuating unit includes
a plate coupled to said manual operating member such that said plate co-rotates with said manual operating member, and
a pair of switch actuators, each of which is provided on said plate.

12. The electric door lock as claimed in claim 1, wherein said manual operating member includes a shaft that extends into said lock housing, and a knob that is disposed externally of said lock housing and that is connected to said shaft, said second protrusion being provided on said shaft of said manual operating member.
